(19) United States
(12) Patent Application Publication
(10) Pub. No.: US 2010/0063961 A1
(43) Pub. Date: Mar. 11, 2010

(54) Reverse Tagging of Images in System for Managing and Sharing Digital Images

(75) Inventors: Bertrand Guiheneuf, Paris (FR); Jean-Marie Hullot, Bougival (FR); Manuel Colom, Paris (FR); Olivier Gutknecht, Paris (FR); Sebastien Maury, Paris (FR)

Correspondence Address: PERKINS COIE LLP, P.O. BOX 1208, SEATTLE, WA, 98111-1208, US

(73) Assignee: Fotonauts, Inc.

(21) Appl. No.: 12/553,956

(22) Filed: Sep. 3, 2009

Related U.S. Application Data
(60) Provisional application No. 61/094,850, filed on Sep. 5, 2008.
(60) Provisional application No. 61/191,335, filed on Sep. 5, 2008.

(51) Int. Cl. G06F 17/30; G06F 15/16

(52) U.S. Cl. 707/622; 707/739; 707/769; 709/206; 707/E17.108; 707/E17.033; 707/636; 707/E17.046

(57) ABSTRACT

An online application and service operates over existing photo hosting services to allow users to share digital photos hosted by multiple online photo hosting services, including ability to automatically discover relevant photos, to create a photo “album” that includes photos hosted by multiple different online services; to automatically discover relevant content and add it to an album; to chat and/or send instant messages in relation to shared photos; and automatic notifications of events of interest to users. The service includes a server based application and an associated client-side application with a graphical user interface. The technology further includes a method of “reverse tagging”, i.e., automatically adding semantic tags to an online album and any photos included in it, by automatically performing an online search of an information resource in response to a user creating a name for the album, and applying results of the search as tags to the album.

### RELATED APPLICATIONS

This application claims the benefit of U.S. provisional application No. 61/094,850 and U.S. provisional application No. 61/191,335, both filed on Sep. 5, 2008, which are incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

At least one embodiment of the present invention pertains to digital image applications, and more particularly, to a digital image application and system for sharing, enrichment and automatic discovery of, and collaboration regarding, digital images, such as digital photos.

### BACKGROUND

Digital images such as photos, once captured, are in a sense “imprisoned”. Most digital photos, once captured by a user, languish in the user's camera memory device or computer hard drive indefinitely, only being viewed once or very infrequently. The vast majority of digital images are never uploaded to the Internet, despite the variety of online photo hosting services available today. There are several reasons for this.

With many such online services, uploading photos is difficult and/or time-consuming, often taking hours to upload a batch of images. Tagging of digital photos (associating descriptive data or metadata with photos) must be done manually, which is time consuming and tedious, such that many users fail to do it. The ability to work with others to create photo albums, add photos, discuss issues, or be notified of changes, are all either difficult or missing altogether. In addition, photo search capabilities with existing online photo hosting services are poor. Rich tagging, the absence of metadata, and other signals, that would allow better results are unavailable for the most part. Tracking of where the user's photos are published and who has seen them is virtually non-existent.

Digital images that are intended for sharing are typically emailed between users, or in a minority of cases, uploaded to an online service where they are available only to others who use the service or visit its web site. Further, digital images that are uploaded to an online service are typically uploaded with “all rights reserved” and are therefore off-limits for others to use or re-use.

Consequently, many people simply do not bother to use existing online photos hosting services, and when they do, these services do not provide the ability to use and enjoy photos to their full potential.

### SUMMARY

The technology introduced here includes an online application and service, which operate “on top of” existing photo hosting services (Flickr, Picasa, Photobucket, ImageShack, etc.), to enable users to share and converse regarding digital photos hosted by multiple online photo hosting services, including the ability to automatically discover relevant photos, to create a photo “album” (a logical container of digital photos) that includes photos hosted by multiple different online services; to automatically discover relevant content and add such content to an album; to chat and/or send instant messages in relation to shared photos; and automatic notifications of events of interest to users. The service includes server-side functionality as well as corresponding client-side functionality that provides a graphical user interface (GUI).

The technology further includes a method (called “reverse tagging”) of automatically adding semantic tags to an online album and any photos included in it, by automatically performing an online search of an information resource in response to a user creating a name for the album, and applying results of the search as tags to the album.

The technology further includes a technique of network based tagging of an online image such as a digital photo, which comprises assigning and centrally storing a plurality of different sets of tags to a single photo, which can be shared by a plurality of online users, where each set of tags is associated with a different album. Each album can also potentially be associated with a different user.

The technology further includes a method of enabling a plurality of users to share image content (e.g., digital photos) which comprises cross-synchronizing image content hosted by a plurality of online image hosting services, where such cross-synchronization may include synchronizing image content on a client-side host with two or more other image hosting services. Any image which a user desires to share will be automatically and virtually instantaneously synchronized with the server side photo store and the client-side photo stores of any other users of the application who have access to the photo. A user's local client device and the network cloud are treated as if they are one and the same.

The technology further includes the ability for multiple users to perform distributed and concurrent editing of an image album, which has a separate instance on each user's local machine, with real-time (dynamic) or near real-time synchronization between all such instances of the album in response to users' edits, with ability to track such edits by individual user.

Other aspects of the technology introduced here will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates an example of the home page of the user interface (UI) provided by the Fotonauts client, according to one embodiment;

FIG. 2 shows a dialog window for selecting access permissions/restrictions for a new album;

FIG. 3 shows a dialog window for selecting the type of license which will apply to an album;

FIG. 4 illustrates a user interface display screen showing a page of an album named “World Heritage Sites” and a sidebar for user-to-user communication about photos;

FIG. 5 illustrates part of a user interface display screen, listing an album and pages within the album;

FIG. 6 illustrates a user interface display screen showing an example of the results of a search performed automatically by the client in response to a user naming an album, where the results include a wiki article and a map;

FIG. 7 shows another example of search results, including a “Keep Article” button that allows a user to cause the client to associate the article with an album as a tag;

FIG. 8A schematically illustrates a data schema for managing photos and related metadata, according to one embodiment;

FIG. 8B is a flow diagram illustrating a process of associating a tag with an album;

FIG. 8C is a flow diagram illustrating a process of reverse tagging;

FIG. 9 is a block diagram showing an overview illustrating the cross-synchronization between server system, multiple online hosting services and multiple clients;

FIG. 10 shows a database schema used by the Fotonauts system, according to one embodiment;

FIG. 11 illustrates an example of the architecture of the Fotonauts client, according to one embodiment;

FIG. 12 illustrates an example of the architecture of the Fotonauts server system, according to one embodiment.

FIGS. 13A and 13B are different views of the interactions between components of the Fotonauts server system, according to one embodiment; and

FIGS. 14A, 14B and 14C are different views of the interactions between components of the Fotonauts server system at the network level; and

FIG. 15 is a block diagram of a computer system that can be used to implement the Fotonauts client or server systems.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

A digital image system and application for sharing, enrichment and automatic discovery of, and collaboration regarding, digital images is described. The system and service are called “Fotonauts®” herein to facilitate description. In one embodiment, the Fotonauts system includes both client-side features, which include (among other components) a user interface component, and server-side features which include (among other components) a web server component.

Note that while digital photos are discussed herein as an example, the technology introduced here is not limited to use with photos per se. Hence, “digital images” in the context of this description can also include graphical images and/or any other form of image that can be stored, communicated or displayed by a processing device in digital form.

### Overview and Example Use Scenario

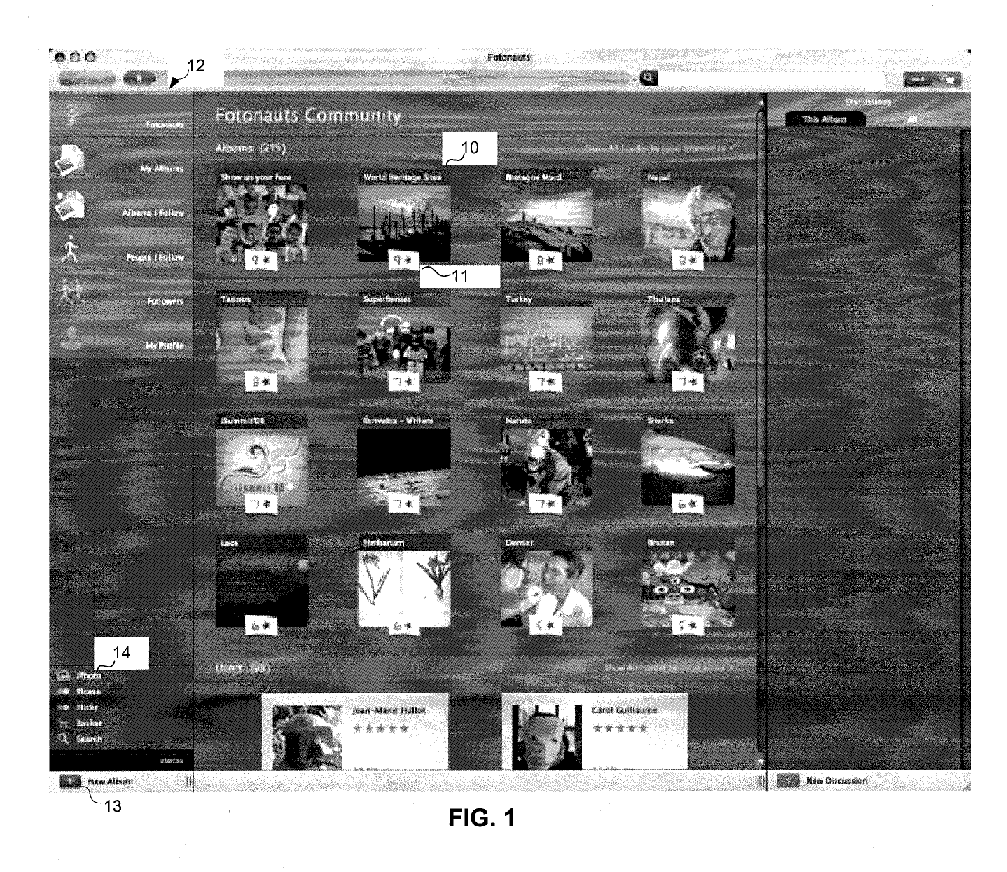

FIG. 1 illustrates an example of the home page of the user interface provided by the Fotonauts client, according to one embodiment. Immediately after installation, the Fotonauts client will automatically synchronize data with the Fotonauts server, to enable the client to access and display all albums and photos made available by other Fotonauts users. The homepage shows thumbnail images 10 representing all of the albums in the Fotonauts “community”, i.e., all of the albums that are made available by all Fotonauts users at least for viewing. By clicking on any of these thumbnail images 10, the user can view the photos in the corresponding album. Each album may be displayed with a star rating 11, as shown, to indicate the degree of popularity of the album or relevance to user-specified search criteria.

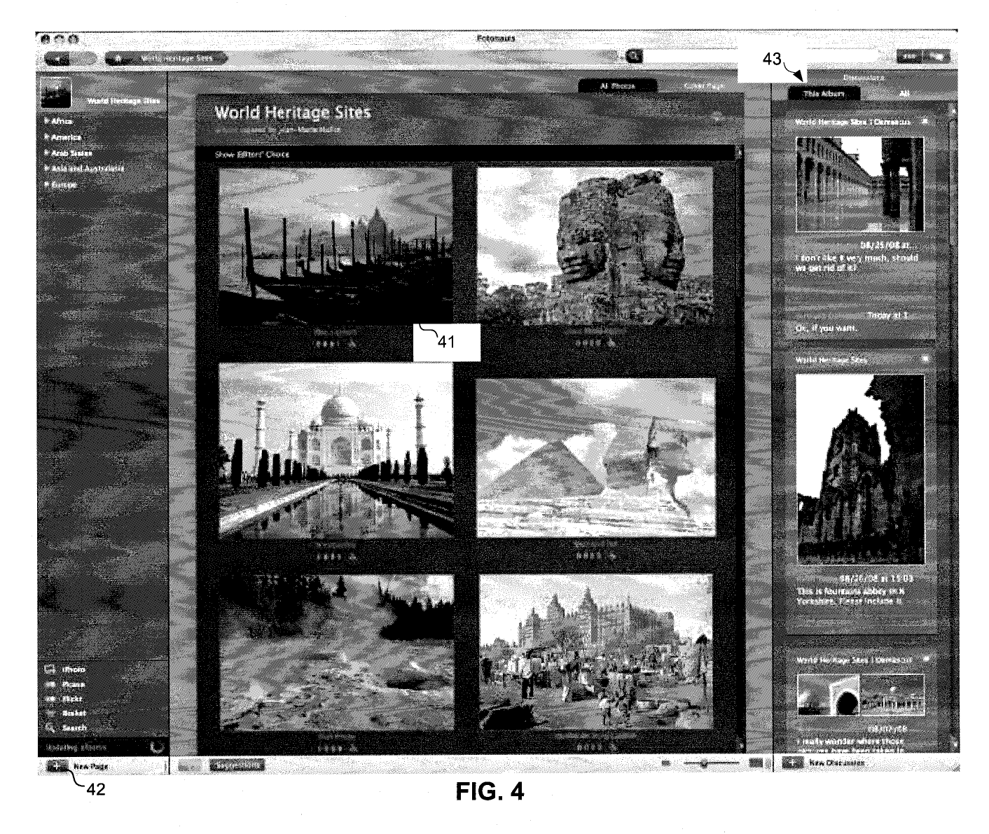

By clicking on the appropriate button in the left panel 12 of the homepage, the user can view a listing of: his own albums (“My Albums” button), albums that he has chosen to follow (“Albums I Follow” button; the concept of “following” is discussed below), people who he has chosen to follow (“People|Follow” button) and their albums, people who have chosen to follow him (“Followers” button) and their albums, and his own user profile (“My Profile” button). Once selected, the user can navigate in a conventional manner to view the contents or lower levels of any of these categories. In response to the user clicking on the icon or name of an album (e.g., from a listing produced by selecting “My Albums” or “Albums|Follow”), the user interface will display thumbnail images 41 of all of the photos in that album, as shown in FIG. 4. The user can also click the appropriate button in the left panel 12 to view his photos on any of various online photo hosting services, such as iPhoto, Picasa, Flickr, etc. (a separate button 14 is provided for accessing each photo hosting service), to access an electronic shopping basket, or to invoke a search engine for searching for photos, users, or non-photo content.

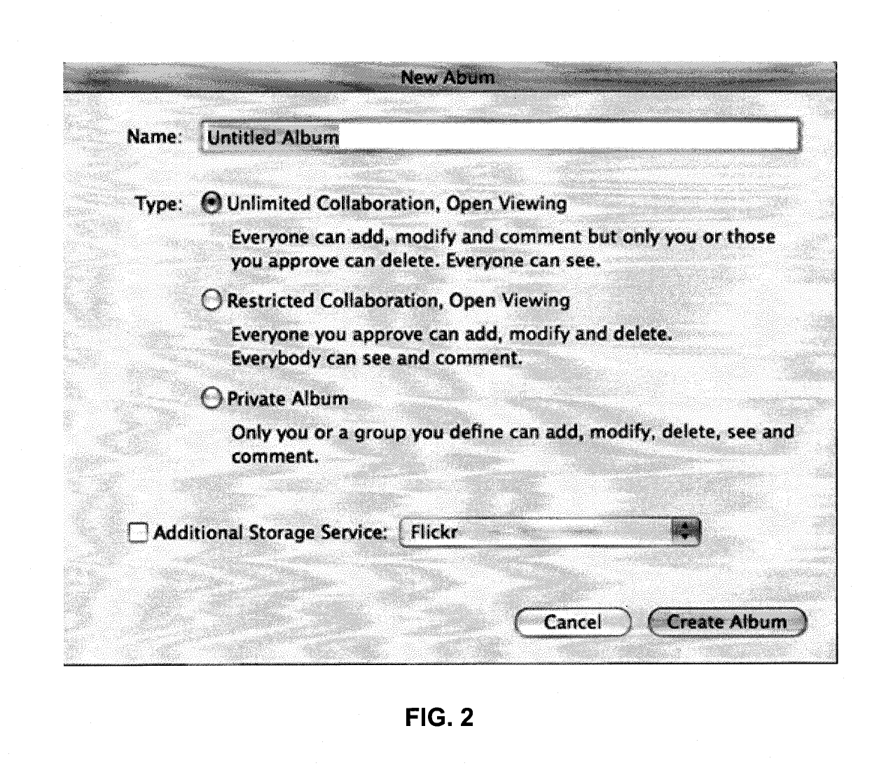

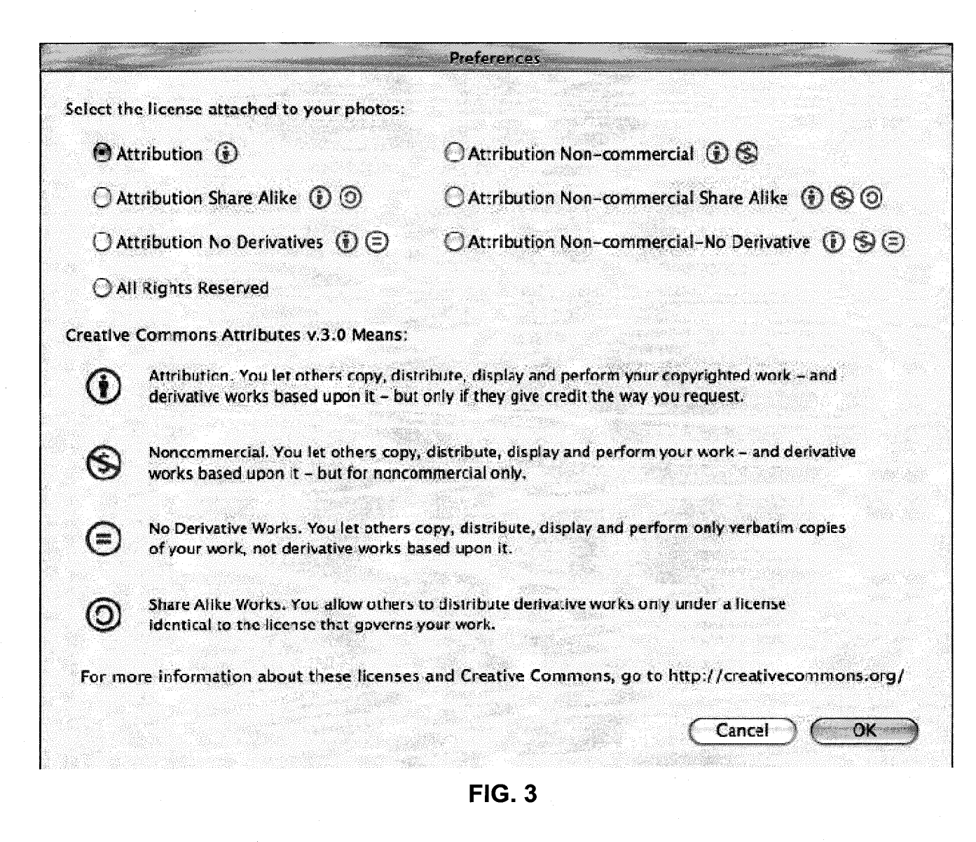

In an example of a basic use scenario, after installing the Fotonauts client, the user will be prompted to tell the client where to locate his locally stored photos, e.g., by pointing the application via a dialog window to the correct folder(s) on his hard drive. Next, the user may choose to create a new album by clicking on an appropriate user interface control, such as a “New Album” button 13 (FIG. 1) displayed on the client user interface. In response, the user will be prompted to select the name and access options for the album, for example by a dialog window such as shown in FIG. 2. The user will also be prompted to select the online photo service(s) to which he wants the album and its contents to be published, if any (e.g., Flickr, Picasa), as also shown in FIG. 2. Additionally, the user will be prompted to specify the type of license that will apply to the photos in the album, for example by a dialog window such as shown in FIG. 3.

In response to the user inputting the name of the album and clicking the “Create Album” button (FIG. 2), the client will automatically perform an online keyword search for content that is relevant to that name, as discussed further below. Any of the results of the search can be selected by the user, and in response to such selection, each selected result item is automatically defined as a page (subset) of the album and is defined as a semantic tag of the album.

The user can add photos to the album by simply drag-and-dropping thumbnail images of the photos onto the album's icon on the user interface. As soon as any photo is added to the album, that photo and its inherited tags automatically will get published to the selected online service(s).

### Image Discovery

With the client installed the user can access both the user's hard drive based images and those hosted on online photo services, such as Flickr, Picasa, etc. In one embodiment, the client automatically begins to search for and discover these photos as soon as it is installed and operational on a user's client machine. The user may be prompted by the client to specify a local folder in which to search for such photos and/or to specify a web hosting service (and to provide appropriate authentication information) to search for such photos.

The Fotonauts client automatically discovers and displays thumbnails of images from various sources. For example, on a Mac computer they may be discovered from iPhoto, from the user's hard disk or a flash storage device in the user's camera. On a PC, they may be discovered from Picasa, the user's hard drive, or a flash device, for example. The Fotonauts system will automatically authenticate the user on the specified online services, using authentication information provided by the user. Once the photos are discovered, the user can then drag-and-drop the discovered photos into one or more of his albums.

### Organizing and Enriching Images

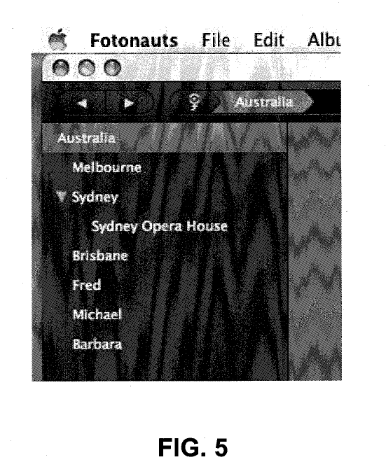

Before a user begins to use his photos, the Fotonauts client enables the user to create digital containers for them, referred to herein as “albums”, which can also be called “photo boxes”, “shoe boxes” or just “boxes”. When the user creates an empty album, as soon as he gives the empty album a name, the client automatically begins to enable the user to enrich the album by adding content to it, as discussed below. As in the physical world, an album has a cover (e.g., an image) and inside it can contain images. An album is a collection of one or more logical data containers called “pages” or “envelopes”. Initially, an album includes a single blank page. Within an album the images can be organized in a hierarchy of pages, as shown in FIG. 5. FIG. 5 illustrates part of a user interface display screen displayed by the Fotonauts client, listing an album and pages within the album. In FIG. 5 an album named Australia includes pages named Melbourne, Sydney, Brisbane, Fred, Michael and Barbara. Further, the Sydney page includes a page called Sydney Opera House. Each album has a user-provided name, and pages within albums can also have user-provided names.

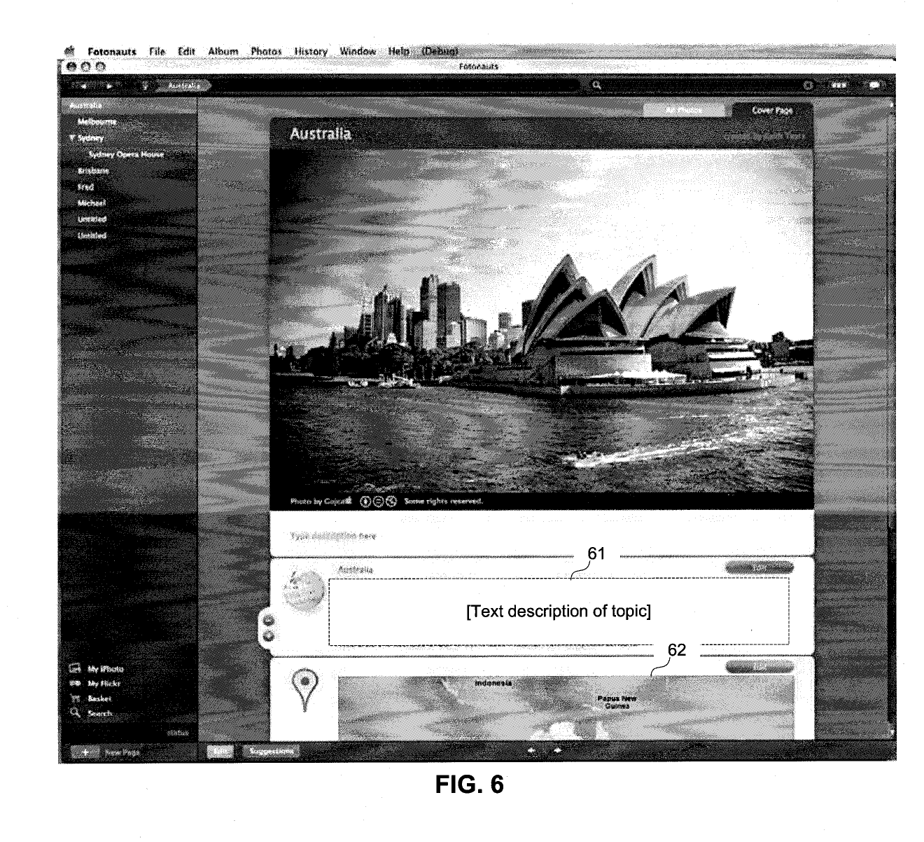

Assume for example that the user creates an album for images taken on a trip to Australia. When creating the album the user can name it “Australia”. As soon as the album has a name, the client automatically begins to look for content to attach to the album. In one embodiment, the client performs a keyword search, using the album's name as keyword, to search one or more predetermined content sources, such as Wikipedia (currently accessible at the web site http://www.wikipedia.org/), for example, via their published APIs. The search results are displayed in the user interface, as shown by the example display screen of FIG. 6. In this example, the retrieved content includes a wiki article 61 about Australia and a map 62 of Australia. If the album was for images the user took at a recent Bob Dylan concert, the user might call the album “Bob Dylan”; in that case the client might retrieve a wiki article on Bob Dylan or a news story about the concert from Daylife or Google News, for example.

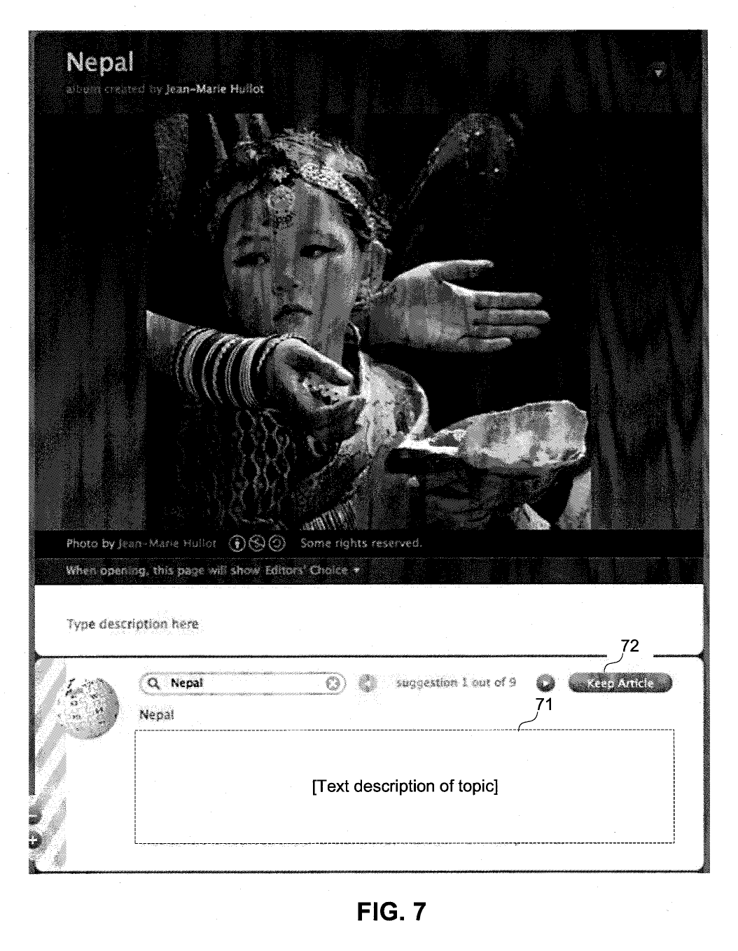

In one embodiment, the search results include information from a content source, such as one or more wiki articles (for example, from Wikipedia). The search results can include other content in addition to, or instead of, wiki articles, such as one or more digital images. The user can select from among the displayed search results, and any such selections by the user are immediately and automatically assigned as semantic tags of the album by the client. For example, in the example display screen of FIG. 7 the search results include a wiki article about Nepal. In response to the user clicking on the “Keep Article” button 72, the displayed article will be associated with the current page as a new tag of that page. Furthermore, any images which are subsequently added to a page in an album automatically inherit all of the tags of that page and of any “ancestors” of that page within the page hierarchy within the album.

Hence, the selected search results turn an empty/plain album into one that is already beginning to have rich meaning, even before the user has put a single image into it. In addition, the user can add the uniform resource locators (URLs) of one or more web sites as tags associated with the album.

In the Fotonauts' client-side user interface, once the first page has some content associated with it (through the above-described procedure), the cover of the album ceases to be plain/blank. It is then decorated with meaningful information relating to the images that will later be inside the album.

From this starting point the user can make the album even richer. The client allows the user to define pages (envelopes) within an album (photo box) like sub-folders, for example, by clicking on a “New Page” button 42 (see FIG. 4) in the user interface. Assume the user visited Brisbane, Sydney and Melbourne while in Australia. The user might want to add the names of all of the cities, or tourist attractions within the cities, as envelopes. Pages can contain other pages. For example, a page for Sydney, Australia might contain another page marked Opera House. If the user traveled with family or friends, the user might add pages for each of their names, as in the example of FIGS. 5 and 6. All of this can be done before adding a single photo to the album.

As noted above, the Fotonauts client automatically discovers and displays thumbnails of images from various sources. The user can then drag-and-drop the discovered photos into the appropriate pages within an album.

To place images in the album, the user drops them on top of the icons of the relevant pages in order to place the images in those pages. Images of Sydney, for example, can be dropped on the icon of the pages for Sydney. Similarly, images of the user's family can be dropped over their pages. An image from Melbourne, of a family member, can be dropped on both the Melbourne page and the page for the person. As the user does this the user's empty album, with the rich content previously added to it, begins to fill with images.

The user can also authorize Fotonauts to allow access to his web hosted images on any of various online hosting services, such as Flickr, Facebook, etc. These too can be drag-and-dropped into a user's album.

### Tagging

As noted above, an album or a page within it can be tagged simply by giving it a name and selecting one or more results of the search that is automatically performed in response to inputting the name. Each time a search result is selected, a node representing a page is created under the root node of the hierarchy (which represents the album), and the new node is automatically tagged with that content. After inputting album and page names just once, the user can then cause all of his photos to be tagged automatically with that content simply by drag-and-dropping the photos onto the icon of the empty album or the appropriate page(s) within the icon; this approach is called “reverse tagging” to facilitate description. Photos inherit all of the tags of the pages and albums in which they reside.

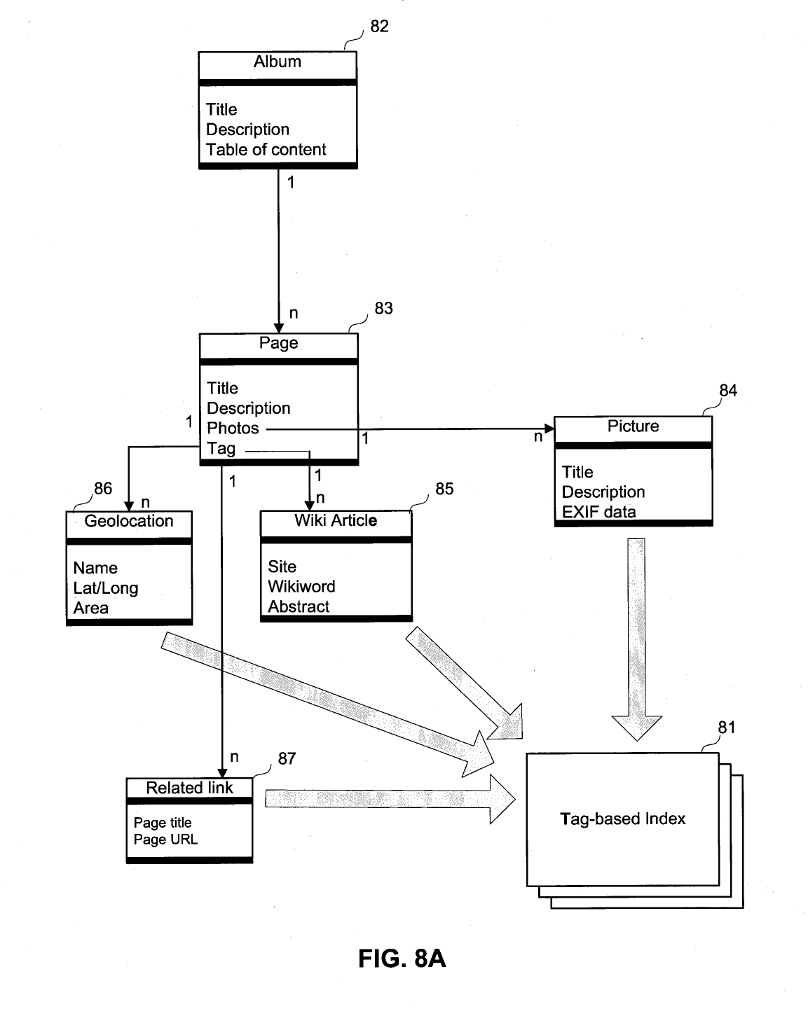

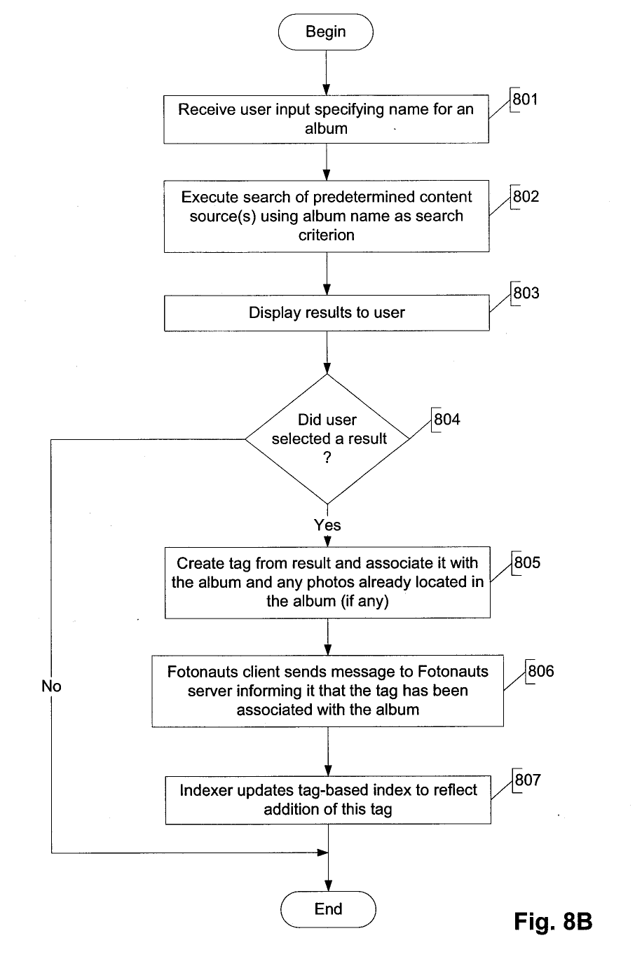

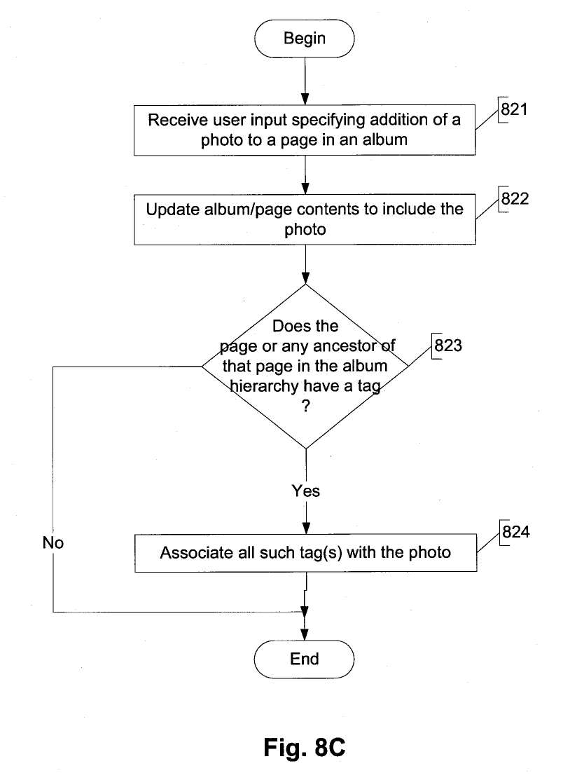

Thus, a given photo is “reverse tagged” automatically when it is added to a page that has one or more tags, and a photo normally inherits all tags from all pages in the content hierarchy that are “ancestors” of the page that contains the photo. Tagged photos are then added to a tag-based index 81 (FIG. 8A). Photos on a page can be ordered on the page automatically and dynamically by the system (e.g., by date and/or rating) or explicitly by the user (i.e., “editor's choice”).

Thus, tagging of photos, which once took hours (or was not done at all), can now (with the technology introduced here) be accomplished in minutes or less. All of the images are tagged appropriately. So for example, within the Sidney, Australia album, an image in the Opera House page that is also within the page for Barbara, will be tagged Australia, Sydney, Opera House and Barbara. Further, the maps, articles and other rich content added to the user's album are all part of the index built from the album. When the user wants to search for images, this rich content can be used to help find relevant images. For example, a semantic tag such as described above can be used as a search criterion to locate any album, page or photo tagged with that tag.

Any particular photo potentially can be included in multiple albums of multiple users, and further, any particular album potentially can be shared by multiple Fotonauts users. For every album in which a photo is included, there is a separate set of tags associated with that photo. Every set of tags for every photo managed by the Fotonauts system is cached centrally at the Fotonauts server system, in a tag based index. More specifically, for every photo managed by the Fotonauts system, the Fotonauts server system stores metadata including a list of all albums (for all users) that contain the photo, and for each such album, a list of the tags that are associated with that photo in that album.

FIG. 8A illustrates an example of the data schema implemented by the Fotonauts system, according to one embodiment, including the metadata and actual data associated with an album, page, etc. and the tag based index. In the illustrated embodiment, each album 82 includes metadata including a title (name), description and table of contents. An album 82 can contain essentially any number of pages 83, hierarchically organized. Each page 83 includes a title, description, zero or more photos (“pictures”) 84, and zero or more additional tags (semantic tags). The tags of a picture can include, for example, one or more wiki articles 85 (each including site, wikiword and abstract), one or more geographic location (“geolocation”) items 86, and/or one or more related links (e.g., page title and URL) 87. In a general sense, the title and description may also be considered tags, although they are treated somewhat differently from other types of tags. A geolocation item 86 can include, for example, a name, a center point (e.g., latitude and longitude), and an area defined about the center point (e.g., a radius). For a Wikipedia article, “site” indicates the language site from which the client is being serviced, e.g., “en” for English, “fr” for France, etc. The first paragraph of the article can be used as the abstract. Each picture 84 on a page 83 has a title, a description and exchangeable image file format (EXIF) data of the photo.

For every album in which a photo is included, there is a separate set of tags associated with that photo, and all such tags are cached at the Fotonauts server system. In one embodiment, each page of an album has a set of tags (e.g., wiki articles, geolocation, URLs) and a list of pictures associated with it. An indexer continuously processes each photo in the system to find the pages to which the photo belongs. Then the indexer sums up the number of tags of those pages in order to list the tags for that photo.

For example, suppose that a particular photo has been added to three albums/pages, which have the following titles and are arranged in the following hierarchies:
Nepal/Kathmandu
Asia/Nepal/Kathmandu
World Heritage/Nepal

Suppose further that each of these pages has a wiki article associated with it, with the same name as its page title (to simplify explanation). In that case, the photo will have the following tags: Nepal, Kathmandu, Asia, Nepal, Kathmandu, World Heritage, Nepal. The indexer sums up the tags from each page into one single index entry. And so what is kept, once the indexer has processed the photo, is the list of tags associated with the photo and their respective frequency, which in this example would be: Nepal (3), Kathmandu (2), World Heritage (1), Asia (1).

FIG. 8B is a flow diagram illustrating a process of associating a tag with an album. The illustrated process begins at 801 when a user input specifying the name of an album is received by the Fotonauts client 92. Next, at 802 the Fotonauts client 92 executes a search of one or more predetermined content sources, such as Wikipedia, using the album name as a search criterion. The Fotonauts client 92 then displays the results to the user at 803. If the user selects one of the results (804), then at 805 the Fotonauts client 92 creates a tag from the selected result and associates the tag with the album and, if the album includes any photos, with such photos. At 806 the Fotonauts client 92 sends a message to the Fotonauts server 91 informing it that the tag has been associated with the album. The Fotonauts server 91 reacts to this message by sending an internal message to its indexer indicating this change to the album, in response to which at 807 the indexer updates the tag-based index 81 index to reflect addition of the tag.

FIG. 8C is a flow diagram illustrating a process of reverse tagging. At 821 the Fotonauts client 92 receives user input specifying the addition of a photo (or multiple photos) to a page in an album, such as a drag-and-drop input. The Fotonauts client 92 then updates the contents of the album and the target page to include the photo at 822. If the target page or any ancestor of that page within the album hierarchy has a tag (823), then at 824 the Fotonauts client 92 automatically associates all such tags with that photo. What is meant here by “automatically” is that the user does not have to provide any input that specifies a tag for the photo.

### Sharing and Uploading

At the time of creating an album the user can determine who can see it. The user can choose to share with the general public. Alternatively, the user can share with a select group of friends or family or a private group, say within an agency or a company. Or, the user can make his album private, in which case only the user will see it, and its images will not be indexed for future public search. This capability is illustrated in FIG. 2.

If the user chooses to share with other users, then while the user is creating the album and its pages and drag-and-dropping images into it, the Fotonauts client will begin uploading to the Fotonauts server system in the background automatically without the user needing to think about it. By the time the user's album is complete, high definition versions of the images and the rich content added to them typically will already be available on the Internet (if the user has so chosen). This content can take the form of a copy of the user's desktop based album that can be seen by those the user are allowed to see it, either from the Fotonauts web site or through their Fotonauts desktop client.

If the user is using another photo service, such as Flickr or Photobucket, then the Fotonauts client can also upload the user's pictures to such services, by using the published APIs of those services, at a resolution of the user's choice. Insofar as the destination service supports it, the rich content attached to the pictures that makes sense for the particular service will be uploaded there as well. Tags derived from rich contents for instance can be uploaded to Flickr. The tags will then be dynamically updated when pictures get enriched with additional content through the user's Fotonauts client. As much data as possible will always be synchronized with the services the user uses whenever the data changes.

The Fotonauts client also includes a widget-building tool, using which a user can distribute any of his albums to a web site.

Multi-Service Photo Synchronization with Identity Reconciliation

The Fotonauts system provides multi-service photo synchronization with identity reconciliation. It allows using pictures from various photo services as well as synchronizing pictures among those various online photo services.

Note that the term “synchronization” refers herein to consistency of data maintained at two or more locations, not synchronization in a temporal sense. However, “synchronization” as described herein can be performed synchronously or asynchronously in a temporal sense, as discussed further below.

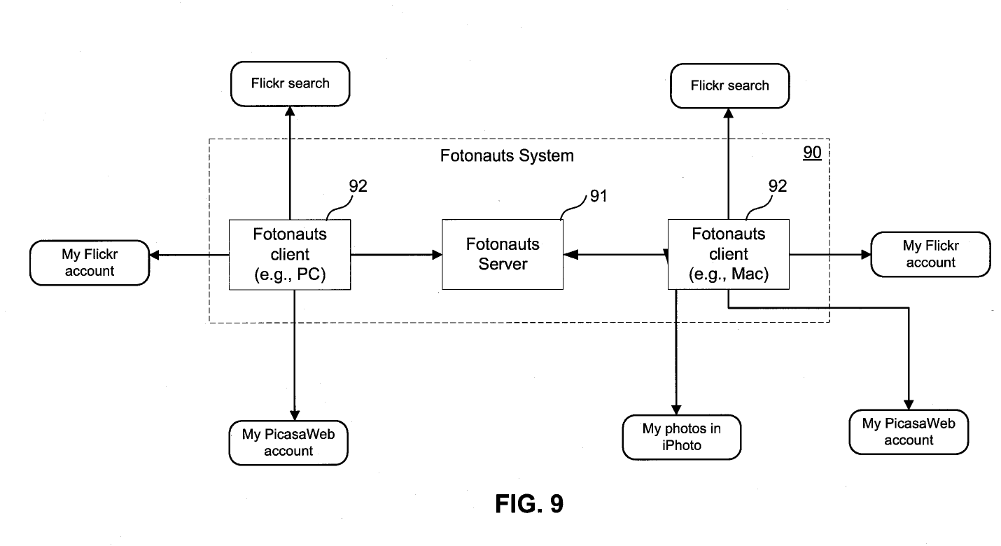

The Fotonauts system 90 includes the Fotonauts server system (or “Fotonauts server”) 91 and one or more Fotonauts clients 92. In general, the Fotonauts system 90 sees the Internet as a graph with the Fotonauts server system 91 at its center, as shown in FIG. 9. Connected to the Fotonauts server system 91 via the Internet are one or more Fotonauts clients 92 for each user. For example, a particular user might have one Fotonauts client at work (which could be for example a PC) and another Fotonauts client at home (which could be for example a Mac) for each user. In general, the Fotonauts server system 91 caches photos to improve performance (e.g., synchronization), but does not permanently store them. All “permanent” copies of photos are stored on users' local machines and on other photo hosting services.

The Fotonauts system 90 supports the following illustrative scenarios:
Adding pictures from a user's computer at home (iPhoto for instance) into an album. The picture is automatically pushed to Fotonauts servers and made visible in the page where it was added. Other clients (including a user's own client running on his computer at work) get immediately notified of this addition (e.g., by using a Jabber instant messenger connection).
Configuring Fotonauts to provide a user with a direct access to his pictures on an online photo storage service (e.g., Flickr or Picasa).
Configuring an album so that each time a user adds one of his pictures to an album, the Fotonauts system 90 sends it to one or more of his other online photo storage accounts (e.g., Flickr or Picasa). Metadata relevant to this picture is extracted from the page where it was added and converted to metadata supported by the target online storage account(s). On Flickr, for instance, the picture is tagged with the album name, the page title, and the wiki articles associated with this page. This mechanism can be configured so that pictures are pushed at the same time to several online accounts, which can be on different online hosting services.
Searching for pictures in Fotonauts or in external services (e.g., Flickr or Picasa), and using found images inside Fotonauts albums. Every image from an external online storage service is marked as “External” by a Fotonauts server and the identity of the original author of the image (a Flickr user, for instance) is automatically recorded at the Fotonauts server as an “External Identity”. Later on, if this Flickr user registers as a Fotonauts user, he can configure his Flickr account. Fotonauts will immediately detect that photos from this “External Identity” have been used and will automatically reconcile the “External Identity” with the new Fotonauts user (i.e., to indicate that they are the same).
Working offline, without any Internet connection and even quitting the application. The next time the user launches the Fotonauts application on his client machine while connected to the Internet, it will resynchronize his work with the Fotonauts server.

### Multi-Client Server Asynchronous Synchronization

In one embodiment, the Fotonauts system 90 also includes a versatile asynchronous synchronization mechanism, which allows synchronization of data not only between Fotonauts clients and server, but also between Fotonauts clients and external photo services. The Fotonauts synchronizer component sees everything as “data feeds” (in the sense of RSS feeds for instance). Rather than synchronizing data synchronously as in typical synchronous client-server systems, the Fotonauts client has an internal representation of the data feed stored on the server system. Each time a modification is made by the user, Fotonauts records the action in a persistent journal and also “activates” a feed synchronization operation. For instance, adding a picture to an album triggers an “add picture X to album Y” action. However, because Fotonauts sometimes cannot immediately send network commands, the user could delete Album Y before the action is even sent. In that case, the action “add picture X to album Y” is ignored (and an action “delete album Y from user's list of album” is triggered). Such actions can be communicated to the server 91 and (through the server) to other clients 92 by using a Jabber instant messaging mechanism/protocol, for example.

Fotonauts thus uses the notion of feed dependency graphs. Actions are not executed individually but are actually always evaluated in the context of a list of things to do. Actions are even scheduled differently depending on the service. For instance, when creating an album with one picture, the album is created first and the picture pushed in the album later when synchronizing with the Fotonauts server. In contrast, when synchronizing with Flickr, the picture is first pushed, and only then can the album creation occur. The feed dependency graph allows synchronization to work with both systems.

When the Internet connection is offline, actions are not triggered immediately but are instead reread from the persistent journal when the user gets back online.

The system allows multiple users to perform distributed, concurrent editing of an image album, which has a separate instance on each user's local machine, with real-time (dynamic) synchronization between all such instances of the album in response to users' edits.

### Multiple Identity Reconciliation

A Fotonauts user can use his pictures stored in various photo storage systems. As such, a user can have multiple identities, e.g., one “Fotonaut identity” which serves as the user's main identity, and several “external identities”, one for each service he uses. However, external identities may exist for a person inside Fotonauts data storage before the person even registers as a Fotonauts user. In the scenario where a user searches for Flickr pictures (for example) to use in his own albums, he may use pictures belonging to a Flickr user who does not yet use Fotonauts. When he uses that other Flickr user's pictures, that other user is added in the Fotonauts system 90 as an orphaned “external identity”, and his Flickr pictures are marked in a Fotonauts database as belonging to this “external identity”.

Later, this Flickr user might become a Fotonauts user and register his Flickr account in order to access his photos stored on Flickr. In that event, Fotonauts detects that the orphan “external identity” is no longer orphan, and is now attached to a Fotonauts user. The Fotonauts server will later take all of the pictures marked as belonging to the “external identity” and will then associate them with the new Fotonauts user. Further, this user may also register his Picasa web account (for example) in Fotonauts and some of his orphan Picasa pictures will be reconciled with his Fotonauts identity so that the Flickr and Picasa pictures which appeared as having separate authors (one for Flickr, and one for Picasa) will now be associated with the same Fotonauts user.

### Multi-Service Publication of Pictures

Although already described above, the multi client-server asynchronous synchronization feature deserves additional discussion. Users can choose to “publish” Fotonauts albums to external photo storage services, as noted above. Here Flickr is used as an example. Each time a user adds a picture to a Fotonauts album, the picture can be published into a Flickr album (called a Set). The Fotonauts client enumerates all of the wiki articles on the page to which the picture was added. The client also enumerates the title of the parent pages in the album hierarchy. All of this information is collected and used as a list of Flickr tags associated with the picture on Flickr. In addition, the client also extracts geolocalization information from the page and sets a Flickr geotag accordingly.

The user can also decide to publish the same album to PicasaWeb and/or Photobucket, etc., or any other service that the Fotonauts system 90 supports. The pictures are thus simultaneously (from the user's perspective) published to the external services.

The following is an example of the process of synchronizing photos between a user's Fotonauts client and the user's Flickr account. Initially, the Fotonauts client logs in to the user's Flickr account, using login/authentication information provided by the user the first time the Flickr account is accessed from Fotonauts. This information is saved locally by the client, so that the user does not have to re-input this information frequently (if at all).

Once logged in to the user's Flickr account, the Fotonauts client uses Flickr's published APIs to get a list of the user's Flickr “Sets”. The client then stores this list locally. If the client already had an earlier version of this list, it does a differencing operation between the two lists to identify any changes (e.g., new Sets or deleted Sets). A similar operation is then done to acquire a current list of all pictures in each of those Sets. The Fotonauts client then requests and receives the binaries (e.g., JPEGs) of all such picture as well as their metadata. In certain embodiments, the pictures are initially requested at less than full resolution, in order to make them accessible to the user as soon as possible. Full resolution versions can then be downloaded at a later, more convenient time (e.g., in the background or in response to a user copying a picture from a Flickr set to a Fotonauts album).

### Collaboration

Consider a scenario in which the user is a parent, and the user and other parents all take the user's children to an event. The Fotonauts system 90 allows the user's album to be shared with the parents and children who were present, and they can all see the pictures the user took. But assume the user wants to allow all of the parents not only to see the album, but also to contribute their own pictures to the album. With the Fotonauts system 90, it does not matter which online photo service(s) they all use normally. Some may use Picasa, others may use Flickr, still others Photobucket or Imageshack.

In one embodiment, as illustrated in FIG. 4 there is a discussion area in the right sidebar 43 of the Fotonauts user interface, that allows people the user chooses, to place images and comments alongside the album. The communications can be implemented by using Jabber, for example; however, the images and comments are saved in a database (e.g., at the Fotonauts server 91) so as to make them persistent. If the receiving user is not logged on when a picture or comment is added by another user, it will be displayed to the user the next time the user logs on and his client synchronizes with the server.

If the user so chooses, he will be able to drag-and-drop suggested images into the album. Those images will then form part of the finished, shared album with the user acting as curator and decision maker as comments and suggestions are received.

In addition, if the user desires, the user can allow the other people to add images to the album without the user's consent, to thereby have a fully collaborative album. In this case the user grants others the right to add images because the user trusts them, or because the user's initial intention was to create a fully collaborative album.

These examples of collaboration work just as well for other types of groups, e.g., a subject-specific group working on images that are important to their subject—such as a group of botanists specializing in Himalayan flora and fauna, or a group of advertising agency employees collaborating with a client on images for a new campaign. Any group can choose to create shared and fully collaborative albums with the group.

External pictures from the Internet can also be added to an album by activating a “Suggestions” option in the Fotonauts user interface. Any image retrieved by the search which is thereby triggered can be drag-and-dropped into an album, as long as the user has permission to add images to the album. The Fotonauts system 90 controls the results produced by the “Suggestions” search to ensure that the license on the picture produced from a “Suggestions” search allows its use. This means that an album owner, or curator, can build rich albums made from the images of other photographers.

### Real Time Conversation

It might be desirable for the user's album to be built in real time with others who are online at the same time as the user. Accordingly, the Fotonauts client enables an instant messaging-like experience, but with images and chat, in the sidebar of the user interface. This can also be implemented using Jabber, for example. If the user is not online to see these contributions, they are saved in a database and shown to the user and other album viewers the next time the user logs on.

### Notifications and Events

Fotonauts users can choose to subscribe to albums or to people; this capability is called “following”. Every user can be “followed” and can be a “follower”. As long as an album is shared and the user has permission to see its content, the user will have a live “event stream” from the people or albums the user follows, for events such as adding or deleting albums, adding or deleting photos to/from albums, adding comments to photos, etc. This event stream, which is coordinated by the Fotonauts server, can be viewed in the Fotonauts client user interface or on the Fotonauts web site when the user is logged in. In one embodiment, a Jabber instant messaging mechanism/protocol is used to convey these event streams, although events are also stored at the server system to provide persistence. In such an embodiment, a separate chat room can be created for each album that is being followed. Some events, if the user chooses, can be deemed important enough that the user is emailed when they occur. Such events might include, for example, the publication of one of the user's images on someone's blog, somebody deciding to follow the user or one of the user's albums, or other events the user designates as important.

### Tracking and Reporting

The Fotonauts system 90 includes a robust tracking and reporting mechanism. All images are tracked while in the Fotonauts system 90. They are also tracked if they are republished off of Fotonauts, using embedding technology. Such tracking includes, for example, click tracking, re-publishing metrics, and votes gathered. Images and albums can be tracked.

### Distribution

As mentioned above, a user can select the access permissions for an album when the album is created or modify the permissions at any time thereafter. If the user chooses to share his images with the general public, they become available for others to publish inside their Fotonauts albums, and also off of Fotonauts on their blogs, in their social networks, and elsewhere. Viewers simply can request that the image they like be placed into their chosen site. The Fotonauts system 90 then takes the appropriate actions depending on where the user wants to re-publish it (e.g., another Fotonauts album, a blog, on Facebook or MySpace, etc.). Embedding the user's images on other sites in this way is a significant factor in getting the user's images seen by others. Just as with a user's Fotonauts album, the Fotonauts service can track and report back to the user every time somebody does this, and also what traffic those images produce. The popularity of the user's image is partly measured by these metrics.

One of the elements of distribution is licensing. The Fotonauts service can offer a wide range of license types to all its members and make sure the license the user chooses is made clear to others.

### Search

All images in the Fotonauts system 90, whether they are stored on the user's local device, on a service like Flickr, or any other Fotonauts-enabled environment, are made constantly available to Fotonauts members, to the extent consistent with their sharing permissions. These images can be voted on, made favorites, ranked, chosen for re-publication if their licenses allow it, and so on. As users make these choices, the Fotonauts system is constantly indexing and ranking images. The net result of this process is a search engine, accessible at the Fotonauts web site, that is capable of distinguishing between images that are relevant, based on popularity and other variables. As mentioned above, images can be displayed to a user with a star rating or some other form of popularity or relevance indication.

Relevance can be determined from the data associated with images; popularity can be determined from rankings derived from measuring the collective actions of all users or a large subset of users. Over time an increasing number of images will carry ranking information, such that the result for users will be improved image search.

### Database Management System

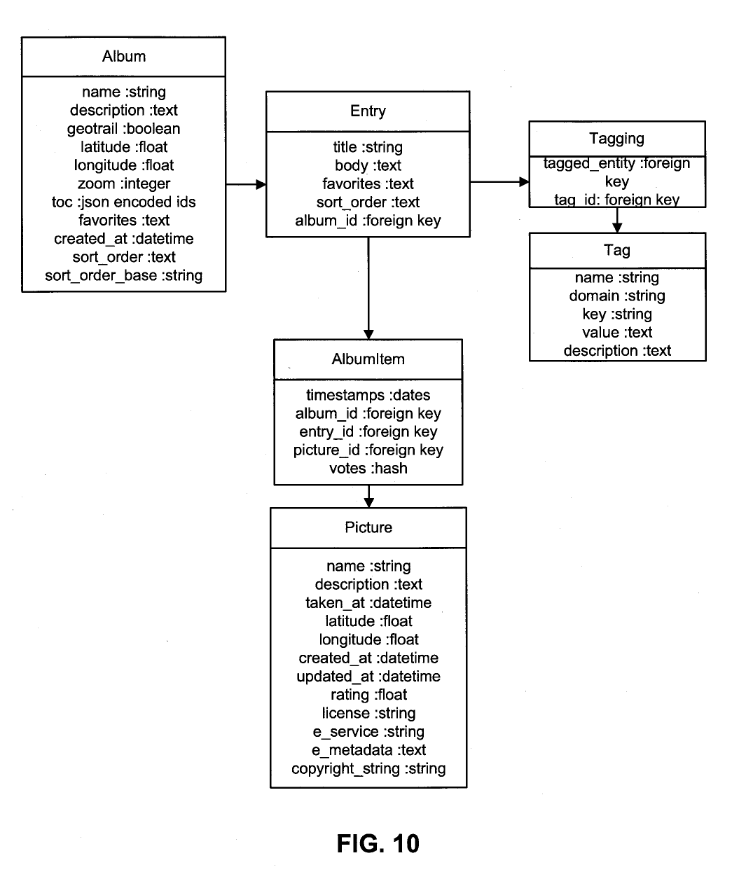

The Fotonauts system 90 can implement a relational database management system (RDBMS) to manage albums, photos and other content. FIG. 10 illustrates an example of the RDBMS implementation, according to one embodiment. It can be assumed that essentially the same RDBMS schema is implemented by both the client and server. The RDBMS defines several types of data entities, namely, Album, Entry, Albumltem, Picture, Tagging and Tag. FIG. 10 illustrates the metadata elements included in these data entities and their data types, as well as the relationships between these data entities.

### System Architecture

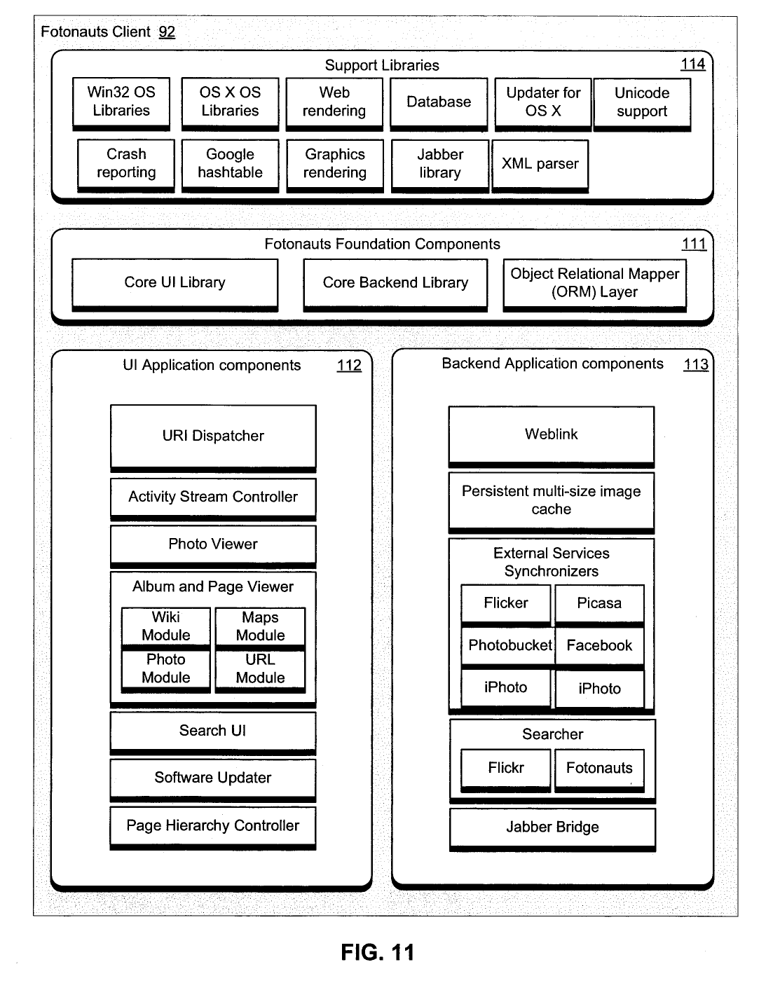

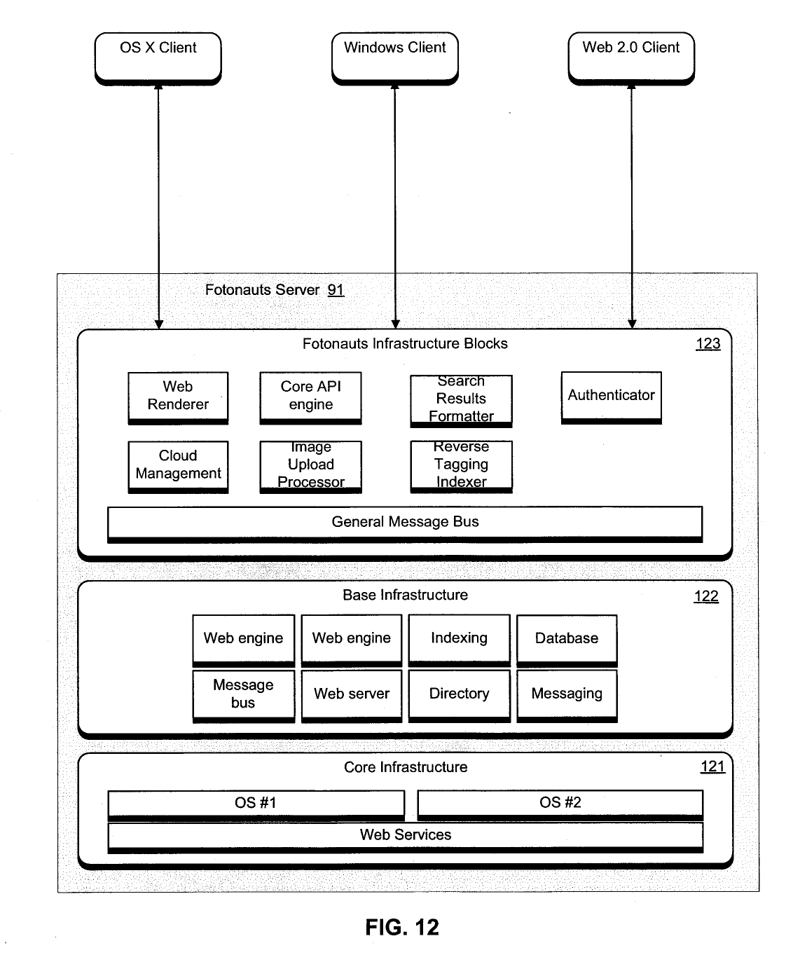

FIGS. 11 and 12 illustrate an example of the architecture of a Fotonauts client 92 and the Fotonauts server 91, respectively, according to one embodiment. All of the illustrated components can be implemented in, for example, programmable circuitry (e.g., one or more microprocessors) programmed with software and/or firmware, or in specially designed hardwired circuitry. The hardware used to implement these components can be conventional computer hardware such as commonly used to implement client/server architectures today.

As shown in FIG. 11, a Fotonauts client 92 includes a number of foundation components 111, user interface (UI) components 112, backend application components 113, and support libraries 114. The foundation components 111 include a core UI library, a core backend library, and an object relational mapper (ORM) layer. The core UI library is responsible for presenting data to users. The core backend library is responsible for manipulating objects in the application as well as managing the network stacks. The ORM layer is a modeling layer that is in charge of managing the persistence of the object-oriented stack of objects into a database.

The UI components 112 include a uniform resource identifier (URI) dispatcher (for managing user navigation within Fotonauts data), an activity stream controller, a photo viewer (e.g., PhotoView for Windows), an album and page viewer, a search UI (for searching users, albums and photos), a software updater and a page hierarchy controller. The album and page viewer includes, in the illustrated embodiment, a wiki module for accessing wiki content (e.g., Wikipedia), a photo module, a maps module and a URL module. The URI dispatcher translates user actions into computer-representable actions (similar to web URLs). The activity stream controller is responsible for providing feedback to users regarding network activity. The photo viewer is capable of showing a list of images to a user, either as a grid or as a slideshow. The album and page viewers display pages made of several visible modules (e.g., Title, Photos, Description, Wikipedia articles, Related links). The Wiki module is responsible for displaying wiki article abstracts (usually the first paragraph of a wiki article). The photo module displays the photos that have been added to the current page. The map module displays the geographic zone that has been associated with the current page. The URL module displays the list of related links added to the current page. The search UI provides a user interface for executing searches. The software updater allows for updates of the client-side software. The page hierarchy controller is responsible for handling user actions related to the hierarchy of pages in an album. For example, when the user clicks on “Add Page”, the page hierarchy controller gets called and updates the underlying data model to create a new page within the current album. This will in turn update the user interface to display the newly created page.

The backend application components 113 include a Weblink module, a persistent multi-size image cache, a set of external synchronizers, a searcher (search engine), and a Jabber bridge. The external services synchronizers implement the above-described functionality of the synchronizing data between Fotonauts and other photo hosting services (e.g., iPhoto, Flickr, Picasa). There may be a separate synchronizer for each such hosting service. The Weblink module is responsible (on the client side) for synchronizing data (e.g., images) between the Fotonauts client 92 and the Fotonauts server 91. The Jabber bridge implements the above-described network communications, including sending messages about actions performed (e.g., album updates), event notifications, user comments, etc.

The support libraries may include support libraries for any one or more of the following, for example: Win32 operating system (OS) libraries, OS X OS libraries, Web rendering (e.g., WebKit), database (e.g., SQLite), updates for OS X (e.g., Sparkle), Unicode support (e.g., ICU), crash reporting (Google breakpad), Google hashtable, graphics rendering (e.g., Cairo), a Jabber library (e.g., Gloox), and an XML parser (e.g., libxml2). Note that all specific product and service names mentioned in this description are mentioned only for purposes of explanation and not limitation.

Referring now to FIG. 12, the Fotonauts server 91 includes a core infrastructure 121, a base infrastructure 122 and a set of Fotonauts infrastructure blocks 123. The core infrastructure 121 includes, for example, an instance of one or more operating systems (e.g., OpenSolaris, Linux) as well as Web services (e.g., Amazon Web Services EC2-S3).

The base infrastructure 122 in one embodiment is based on open source software and includes one or more Web engines (e.g., Ruby on Rails, Merb), a Web server (e.g., lighttpd), an indexing module (e.g., Lucene), a database (e.g., MySQL), a messaging module (e.g., ejabberd), a message bus (e.g., AMQP/Stomp), and a directory service (e.g., LDAP).

The Fotonauts infrastructure blocks 123 includes a web renderer, a core API engine, a search results formatter, an authenticator, a cloud management module, an image upload processor and a reverse tagging indexer, all communicating over a general message bus. The reverse tagging indexer builds the tag-based index 81, described above.

Communication between conventional clients (e.g., OS X or Windows based) and the Fotonauts server system 91 can be, for example, via Atom Feeds with a Fotonauts-specific model, via the AtomPub API with a Fotonauts generic model, or via XMPP realtime API with embedded Atom fragments, or any combination thereof. Communication between Web 2.0 clients and the Fotonauts server system 91 can be, for example, via XMPP realtime API with embedded JSON fragments over HTTP and/or via Ajax/JSON protocol.

### System Interactions

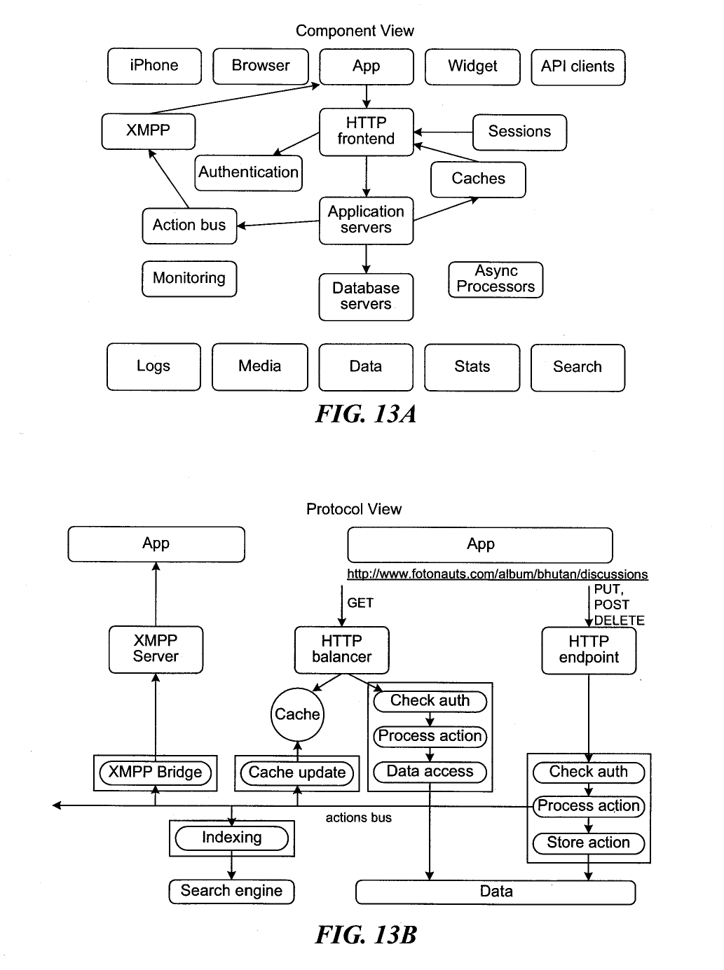

FIGS. 13A and 13B illustrate the interactions between components of the Fotonauts server system 91, according to one embodiment. In particular, FIG. 13A shows a component-level view of the interactions, while FIG. 13B shows a protocol-level view. All of the illustrated components can be implemented in programmable circuitry (e.g., one or more microprocessors) programmed with software and/or firmware, or in specially designed hardwired circuitry, or in a combination thereof.

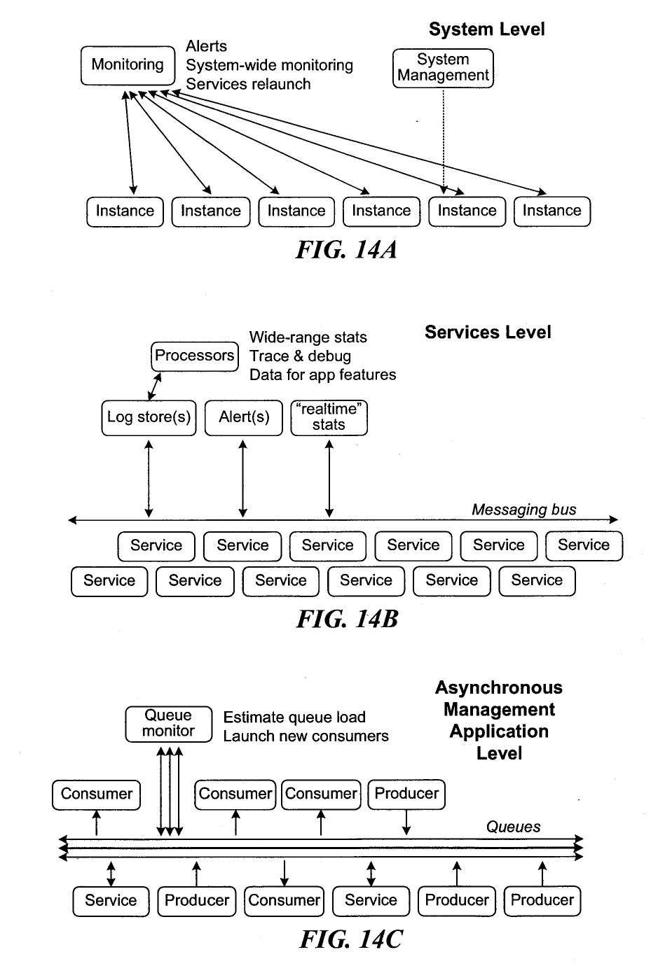

FIGS. 14A, 14B and 14C illustrate the interactions between components of the Fotonauts server system at the network level, in particular, as a cloud computing multilayered model. As shown in FIG. 14A, at the system level the Fotonauts server system 91 can be implemented by multiple virtual server instances that each can handle all the other functions mentioned above, except for monitoring and overall system management, which have their own dedicated server modules. Which particular virtual server instance(s) is/are used at any given time may be based on, for example, conventional load-balancing principles. FIG. 14B shows the Fotonauts server system 91 at the services level, while FIG. 14C shows the Fotonauts server system 91 at the asynchronous management application level.

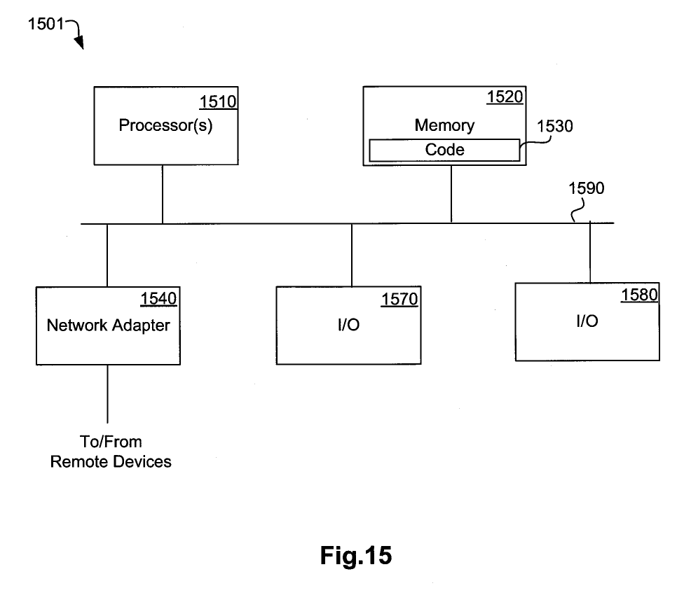

FIG. 15 is a block diagram of a computer system architecture that can be used to implement the Fotonauts server system or any Fotonauts client system or both. A client system or the server system each may be implemented in one or more computer systems having the form illustrated in FIG. 15. Note that in certain embodiments, at least some of the components illustrated in FIG. 15 may be distributed between two or more physically separate but connected computing platforms or boxes.

The computer system 1501 shown in FIG. 15 includes one or more processors 1510, i.e. a central processing unit (CPU), memory 1520, at least one input/output (I/O) device such as a network adapter 1540, and possibly one or more other I/O devices 1570, 1580, all coupled to each other through an interconnect 1590.

The processor(s) 1510 control(s) the operation of the computer system 1501 and may be or include one or more programmable general-purpose or special-purpose microprocessors, microcontrollers, application specific integrated circuits (ASICs), programmable logic devices (PLDs), or a combination of such devices. The interconnect 1590 includes one or more buses, direct connections and/or other types of physical connections, and may include various bridges, controllers and/or adapters such as are well-known in the art. The interconnect 1590 further may include a “system bus”, which may be connected through one or more adapters to one or more expansion buses, such as a form of Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”).

The memory 1520 may be or include one or more memory devices of one or more types, such as read-only memory (ROM), random access memory (RAM), flash memory, disk drives, etc. The network adapter 1540 is a device suitable for enabling the computer system 1501 to communicate data with a remote processing system over a communication link, and may be, for example, a conventional telephone modem, a wireless modem, a Digital Subscriber Line (DSL) modem, a cable modem, a radio transceiver, a satellite transceiver, an Ethernet adapter, or the like. The I/O devices 1570, 1580 may include, for example, one or more devices such as: a pointing device such as a mouse, trackball, joystick, touchpad, or the like; a keyboard; a microphone with speech recognition interface; audio speakers; a display device; etc. Note, however, that such I/O devices may be unnecessary in a system that operates exclusively as a server and provides no direct user interface, as is the case with the Fotonauts server system in at least some embodiments. Other variations upon the illustrated set of components can be implemented in a manner consistent with the invention.

Software and/or firmware 1530 to program the processor(s) 1510 to carry out actions described above may be stored in memory 1520. In certain embodiments, such software or firmware may be initially provided to the computer system 1501 by downloading it from a remote system through the computer system 1501 (e.g., via network adapter 1540).

Thus, a digital image application and system and service for sharing, enrichment and automatic discovery of, and collaboration regarding, digital images have been described.

The techniques introduced above can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

Although the present invention has been described with reference to specific exemplary embodiments, it will be recognized that the invention is not limited to the embodiments described, but can be practiced with modification and alteration.

Accordingly, the specification and drawings are to be regarded in an illustrative sense rather than a restrictive sense.

What is claimed is:

1. A method comprising:
receiving first user input that specifies adding a digital image to an album for digital images, at least one semantic tag having been previously associated with the album; and
in response to the first user input, adding the digital image to the album and automatically associating the semantic tag with the digital image.

2. A method as recited in claim 1, further comprising, prior to receiving the first user input:
receiving second user input, the second user input specifying an attribute of the album;
in response to receiving the second user input, automatically executing an online search of a remote information resource, based on the attribute;
creating the semantic tag from a result of the search and applying the semantic tag to the album.

3. A method as recited in claim 2, wherein said creating a semantic tag from a result of the search and applying the semantic tag to the album is performed prior to any digital image being placed in the album.

4. A method as recited in claim 2, wherein the attribute is a name for the album.

5. A method as recited in claim 2, wherein automatically executing the online search comprises:
automatically executing the online search of the remote information resource by using the attribute of the album as a search criterion.

6. A method as recited in claim 1, wherein the semantic tag comprises a wiki article.

7. A method as recited in claim 1, wherein the semantic tag comprises a network address of a web site.

8. A method as recited in claim 1, wherein the semantic tag comprises a digital image.

9. A method as recited in claim 1, wherein the semantic tag comprises geolocation information.

10. A method as recited in claim 1, wherein the album includes a hierarchy of pages, one of which includes said digital image, and wherein the digital image inherits all tags from the page which includes the digital image and all tags from all pages in the hierarchy that are ancestors of the page that includes the digital image.

11. A method as recited in claim 1, further comprising:
using the semantic tag as a search criterion to locate the digital image.

12. A method comprising:
receiving first user input that specifies a name for an album for digital images;
in response to receiving the first user input, automatically executing an online search of a remote information resource, by using the name as a search criterion;
causing a result of the search to be output to a user, the result including a wiki article;
receiving second user input specifying selection by the user of the result of the search;
in response to the second user input, creating a semantic tag from the result of the search and applying the semantic tag to the album;
receiving third user input that specifies adding a digital image to the album; and
in response to the third user input, adding the digital image to the album and automatically associating the semantic tag with the digital image, wherein the album includes a hierarchy of pages, one of which includes said digital image, and wherein the digital image inherits all tags from the page which includes the digital image and all tags from all pages in the hierarchy that are ancestors of the page that includes the digital image.

13. A method as recited in claim 12, wherein the result of the search further comprises a digital image, and wherein the semantic tag further comprises said digital image from the result of the search.

14. A method as recited in claim 12, wherein said creating a semantic tag from a result of the search and applying the semantic tag to the album is performed prior to any digital image being placed in the album.

15. A method as recited in claim 12, further comprising:
using the semantic tag as a search criterion to locate the digital image.

16. A method comprising:
receiving first user input, the first user input specifying an attribute of an album for digital images;
in response to receiving the first user input, automatically executing an online search of a remote information resource, based on the attribute;
creating a semantic tag from a result of the search and applying the semantic tag to the album.

17. A method as recited in claim 16, wherein said creating a semantic tag from a result of the search and applying the semantic tag to the album is performed prior to any digital image being placed in the album.

18. A method as recited in claim 16, wherein the attribute is a name for the album.

19. A method as recited in claim 16, wherein automatically executing the online search comprises:
automatically executing the online search of the remote information resource by using the attribute of the album as a search criterion.

20. A method as recited in claim 16, wherein the semantic tag comprises a wiki article.

21. A method as recited in claim 16, wherein the semantic tag comprises a network address of a web site.

22. A method as recited in claim 16, wherein the semantic tag comprises a digital image.

23. A method as recited in claim 16, wherein the semantic tag comprises geolocation information.

24. A method as recited in claim 16, further comprising:
using the semantic tag as a search criterion to locate the digital image.

25. A processing system comprising:
an input/output device;
a processor coupled to the input/output device; and
a memory coupled to the processor and storing instructions which configure the processor to perform operations that include
receiving first user input that specifies adding a digital image to an album for digital images, at least one semantic tag having been previously associated with the album; and
in response to the first user input, adding the digital image to the album and automatically associating the semantic tag with the digital image.

26. A processing system as recited in claim 25, wherein said operations further include, prior to receiving the first user input:
receiving second user input, the second user input specifying an attribute of the album;
in response to receiving the second user input, automatically executing an online search of a remote information resource, based on the attribute;
creating the semantic tag from a result of the search and applying the semantic tag to the album.

27. A processing system as recited in claim 26, wherein said creating a semantic tag from a result of the search and applying the semantic tag to the album is performed prior to any digital image being placed in the album.

28. A processing system as recited in claim 26, wherein the attribute is a name for the album.

29. A processing system as recited in claim 26, wherein automatically executing the online search comprises:
automatically executing the online search of the remote information resource by using the attribute of the album as a search criterion.

30. A processing system as recited in claim 25, wherein the semantic tag comprises a wiki article.

31. A processing system as recited in claim 25, wherein the semantic tag comprises a network address of a web site.

32. A processing system as recited in claim 25, wherein the semantic tag comprises a digital image.

33. A processing system as recited in claim 25, wherein the semantic tag comprises geolocation information.

34. A processing system as recited in claim 25, wherein the album includes a hierarchy of pages, one of which includes said digital image, and wherein the digital image inherits all tags from the page which includes the digital image and all tags from all pages in the hierarchy that are ancestors of the page that includes the digital image.

35. A processing system as recited in claim 25, wherein said operations further include:
using the semantic tag as a search criterion to locate the digital image.

36. A method comprising:
providing a service, in a network based computer system, which enables a plurality of users to share digital photos hosted by a plurality of online photo hosting services;
providing a service, in the network based computer system, which enables a user of the plurality of users to automatically discover relevant photos among the digital photos hosted by the plurality of online photo hosting services;
providing a service, in the network based computer system, which enables the user to create a digital photo album that includes photos hosted by the plurality of online photo hosting services; and
providing a service, in the network based computer system, which enables the plurality of users to send real-time messages in relation to shared photos viewable in the context of the digital photo album.

37. A method comprising:
in a network-based computer system, assigning a plurality of different sets of tags to a single photo that is sharable by a plurality of online users; and
centrally storing the plurality of different sets of tags assigned to the single photo, wherein each set of tags is associated with a different one of a plurality of photo albums.

38. A method as recited in claim 37, wherein at least two of the plurality of different photo albums are associated with different users.

39. A method of enabling a plurality of users to share digital images, comprising:
cross-synchronizing digital photos hosted by a plurality of online photo hosting services, including synchronizing digital photos on a client-side host with two or more external photo hosting services.

40. A method comprising:
enabling a plurality of users using a plurality of different machines to perform distributed and concurrent editing of an image album, wherein a separate instance of the image album resides on each user's machine;
in response to edits to the image album by the plurality of users, providing dynamic synchronization between the instances of the album associated with the plurality of users; and
tracking edits by the plurality of users on an individual user basis.
